(19) United States
(12) Patent Application Publication
(10) Pub. No.: US 2007/0300054 A1
(43) Pub. Date: Dec. 27, 2007

(54) Universal BSP tool for porting on embedded systems and an application thereof

(76) Inventors: Shi-Wu Lo, Chia-Yi (TW); Chih-Wen Hsueh, Taipei (TW); Yung-Chieh Chou, Chia-Yi (TW); Hsin-hung Lin, Chia-Yi (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/471,562

(22) Filed: Jun. 21, 2006

(51) Int. Cl. G06F 9/00

(52) U.S. Cl. 713/2

(57) ABSTRACT

An universal BSP tool for porting on embedded systems and an application method thereof are proposed. The universal BSP tool comprises a BSP parser and a code generator, and is used to parse an open reusable document in XML format, BSPXML. Hardware specification of a target embedded platform and booting process of a specific OS or application are described in the BSPXML document. After parsing of the BSPXML document, bootstrap code of a specific embedded OS or application on the target platform can be generated. BSP low-level functions are also provided by the BSP tool for further use in OS and application after booting to control the embedded hardware. The BSP tool can simplify and automate the process of porting to achieve the objective of reducing the time to market for embedded systems.

### BACKGROUND OF THE INVENTION

1. Field of the invention

The present invention relates to a board support package (BSP) tool and, more particularly, to an universal BSP tool for porting on embedded systems and an application method thereof.

2. Description of related art

With continual enhancement of system performance and computing power, embedded operating systems (OSes) play an important role in embedded systems for better and fully utilizing the system resources and may even dominate the performance factors. Porting, in general, is a process which makes necessary changes in a program to run in a different hardware environment. Embedded system developers usually have to port an OS or application in order to run on an embedded system. The hardware dependent low-level code usually has to be changed.

A board support package (BSP) is a layer between the motherboard and the OS, and belongs to the OS. The BSP is used to support the OS so that the OS can run on the motherboard. Different OSes correspond to differently defined BSPs. For instance, although the BSPs of VxWorks and Linux realize the same functions for a certain processor, but their writing and interface definitions may be totally different. Similarly, different hardware platforms define different types of BSPs. For instance, the BSPs of Linux for different processors may be different. Because the programming process of BSP is generally modified on a certain BSP template, the composition of BSP has to be carried out according to the BSP definition of that system so as to keep correct interface with the upper layer OS and well support the upper layer OS.

Today, there are many kinds of embedded processors on the market such as ARM, MIPS, PowerPC, and so on. For product variety, there are different selections and definitions of peripherals. An embedded OS has different BSPs for different processors. Even for the same processor, the corresponding portions of BSP may be different because of difference in peripheral (e.g., change of size or type of external expansion DRAM). Therefore, the composition and modification of BSP has to base on hardware specification to make sure the system can normally operate.

At present, embedded system developers usually build an embedded system using a total solution which may include hardware platform, OS, tool chain, etc, provided by hardware manufacturers. System developers usually need to modify the provided OS in order to meet various requirements of embedded systems, for example, real-time control or smaller footprint. If the provided OS does not fit the requirements at all, system developers have to port another OS to run on the hardware platform. Besides, system developers usually need to port embedded applications in order to execute on a new target hardware platform. It may take much time and effort for system developers to thoroughly understand the hardware specification first and then port the OS or application accordingly. Hardware manufacturers sometimes do not detail their hardware specification, which causes difficulty for system developers in implementing low-level codes, such as bootstrap code or device drivers. Currently, there is no automatic or systematic methodology to ease the porting problem. In fact, system developers are expected to focus on feature improvement or performance tuning instead of porting. Shorten the porting process can shorten the time to market for embedded systems.

The present invention aims to propose an universal BSP tool for porting on embedded systems and an application method thereof to solve the above problems in the prior art.

### SUMMARY OF THE INVENTION

The primary objective of the present invention is to provide an universal BSP tool for porting on embedded systems and an application method thereof to lower the barrier of OS or application porting due to proprietary hardware specification, thereby helping system developers port various OSes or applications to various embedded hardware platforms to meet the variability and fast-growing market requirement.

Another objective of the present invention is to provide an universal and transparent standard for hardware manufacturers to describe their embedded hardware specifications and OSes booting process.

Yet another objective of the present invention is to provide an universal BSP tool for porting on embedded systems and an application method thereof, which can parse OS booting process conforming to hardware specification of the embedded platform described in a BSPXML document, and provides a low-level hardware control function for further use in OS and application after booting to control the embedded hardware.

To achieve the aforementioned objectives, the present invention provides an universal BSP tool for porting on embedded systems and an application method thereof, which uses a BSP parser to parse a BSPXML document conforming to XML format to acquire hardware specification conforming to the embedded platform and booting process of OS or application. The BSPXML document can further be extended by defining a BSP document type definition (DTD). The present invention also uses a code generator to receive information such as hardware specification and booting process generated by the BSP parser and then generates bootstrap code and low-level hardware control functions of the embedded platform to be used by OS or application.

### BRIEF DESCRIPTION OF THE DRAWINGS

The various objects and advantages of the present invention will be more readily understood from the following detailed description when read in conjunction with the appended drawing, in which:

FIG. 1 is a schematic block diagram of the constituent elements of universal BSP tool and hardware platform according to an embodiment of the present invention;

FIG. 2 is a schematic block diagram of the constituent elements of the low-level functions provided by the present invention;

FIG. 3 is an example of SoC Element of BSPXML;

FIG. 4 is an example of Bootstrap Element of BSPXML; and

FIG. 5 is an example of BSPDTD.

### DETAILED DESCRIPTION OF THE PREFERRED EMBODIMENTS

The present invention provides an universal BSP tool for porting on embedded systems and an application method thereof, whose design is based on describing hardware specification and booting process of embedded systems in an open reusable BSPXML document. The BSP tool parses the BSPXML document and generates bootstrap code of a specific embedded OS or application of the target platform. The preferred embodiments of the invention are described below.

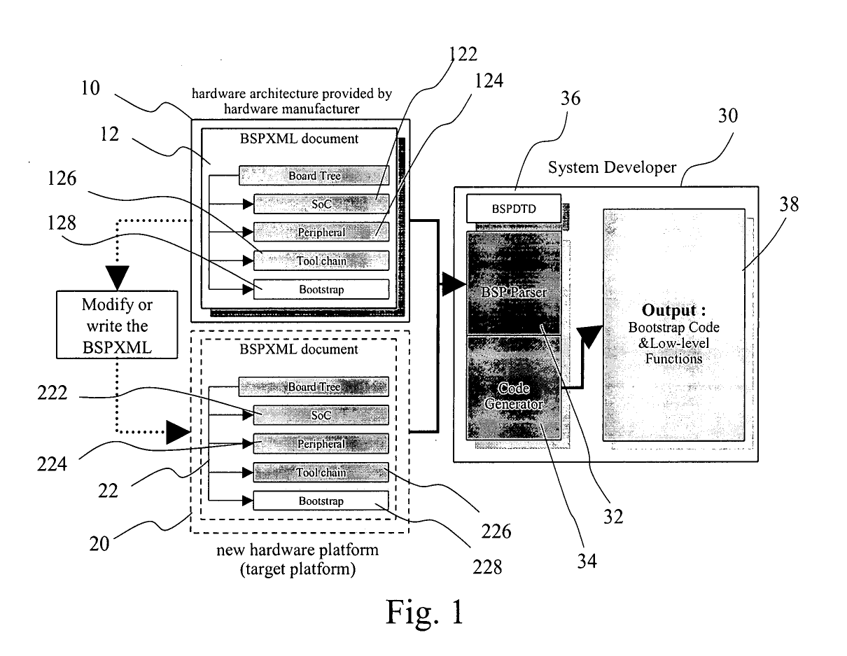

As shown in FIG. 1, the universal BSP tool of the present invention is composed of a BSP parser 32 and a code generator 34. The BSP parser 32 is used to parse BSPXML documents 12 and 22, which describe hardware specifications of embedded platforms and booting process of OSes or applications. The BSPXML document 12 describes a hardware architecture 10 provided by a hardware manufacturer, while the BSPXML document 22 describes hardware specification of a new hardware platform (target platform) 20. The code generator 34 is used to receive information such as hardware specification and booting process generated by the BSP parser 32 and generates bootstrap code and low-level hardware control functions of the target embedded platform to be used by the described OS or application.

The BSPXML documents 12 and 22 conform to XML format, and are open and reusable. The BSPXML document 12 (22) includes four elements: system on chip (SoC) 122 (222), peripheral 124 (224), tool chain 126 (226) and a bootstrap 128 (228). When porting the OS to different hardware platforms (e.g., the hardware platforms 10 and 20), it is necessary to use SoCs 122 and 222 and peripherals 124 and 224 that fit the hardware platforms. The SoC 122 and 222 and the peripheral 124 and 224 are described according to the hardware platforms 10 and 20 respectively. The tool chains 126 and 226 in the BSPXML documents 12 and 22 can further include tools required by OSes or applications such as compiler and make files.

The SoCs 122 and 222 are used to define hardware specification and related codes of the processor of the embedded system, including processor modes, interrupt modes, mask and watchdog timer, etc. Hardware manufacturers can also use the SoCs 122 and 222 to describe the specifications of hardware devices like memory controllers, MMUs and cache memories. Furthermore, various enabling and disabling codes of controllers can also be written in the SoCs 122 and 222. The peripherals 124 and 224 are used to describe peripheral devices in the embedded system such as universal asynchronous receiver/transmitter (UART), Flash and Ethernet controller. Hardware manufacturers will provide basic drivers, and memory mapping of each peripheral device in a BSPXML document.

The tool chains 126 and 226 are used to describe specific tools required by each hardware platform, and makes use of development tools like cross compilers, the low-level application development interface GlibC of the Linux system, debuggers, and libraries to create bootstrap code. The bootstrap process 128 and 228 describe the booting process of OSes or applications (e.g., hardware initialization). System developers 30 can use the code generator 34 to create appropriate bootstrap code and load OS or application into the memory.

In the present invention, a BSPDTD 36 makes use of a list of legal elements to define the rule architecture of the BSPXML documents 12 and 22. The BSPDTD 36 defines BSPXML via element declarations and attribute-list declarations. The element declarations name the allowable set of elements within the BSPXML documents 12 and 22 and specify whether and how declared elements and runs of character data may be contained within each element. The attribute-list declarations name the allowable set of attributes for each declared element, including the type of each attribute value. With the BSPDTD 36, exchange of data between hardware manufacturers and the system developers 30 can be accomplished. At the beginning, a standardized BSPDTD 36 can be first provided. Hardware manufacturers also provide the BSPXML document 12 of the embedded system. When hardware manufacturers add or modify the hardware architecture, new elements or attributes can be defined in the BSPDTD 36 in order to extend the content of the BSPXML document 12.

When a new embedded hardware platform 20 comes out, the hardware manufacturer provides a BSPXML document 22 along with it according to its hardware specification. System developers can write or reuse the BSPXML document 22 to describe the bootstrap process 228 of an OS or application. The BSP parser 32 parses the BSPXML document 22 of the target platform 20, and the code generator 34 then generates bootstrap code for booting the system. System developers need only to compile and link the generated bootstrap code with the OS or application to finish porting and then activate the target platform 20.

When system developers 30 try to port a new OS or application (or one which has never been ported using the present invention) to a new embedded platform 20 using the present invention, they need the BSPXML document 22 of the target platform 20. Hardware manufacturers only has to provide the part of the BSPXML document describing the SoC 222, the peripheral 224 and the tool chain 226 of the target platform 20. The only effort for hardware manufacturers is to get familiar with the BSPXML format and define their specification, by using the unified and open BSPXML. Hardware manufacturers can thus enhance the productivity of embedded system development. It may take some time when system developers 30 first write a BSPXML document to describe the booting process for porting an OS or application since it needs thorough knowledge of the details of the booting process. After a particular OS or application is ported using the present invention, if a different OS is to be ported to the target platform 20, they can use the part related to hardware platform describing the SoC 222, the peripheral 224 and the tool chain 226 of the target platform 20 in the previously composed BSPXML document. After finishing porting of the OS or application, the part describing the bootstrap process 228 of the BSPXML document can be reused for porting on different hardware platforms to achieve the object of repetitive use and avoid the difficulty in the prior art that the system developers 30 have to thoroughly understand the hardware specification first and then port the OS or application accordingly. In general, system developers 30 can use the present invention to port a common OS or application on an embedded platform without much effort.

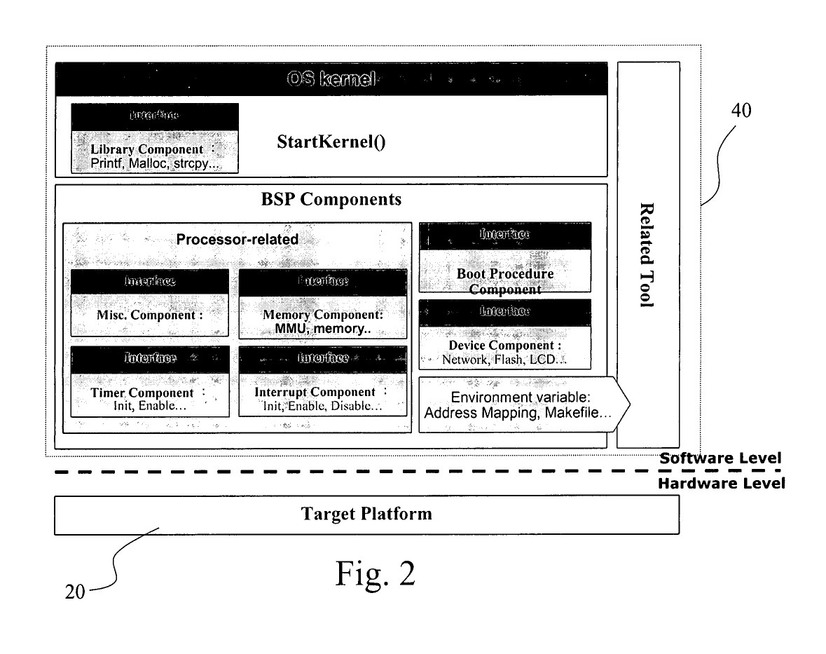

As shown in FIG. 2, the present invention also provides low-level functions 40, which are used in the OS kernel to control the target embedded platform 20, such as timer initialization, disabling and enabling MMU and interrupt, etc. These provided low-level functions 40 could be further used in OS and applications after booting. By the help of these low-level functions 40, system developers 30 are transparent to the implementations of the low-level hardware control functions so that the porting process can be simplified.

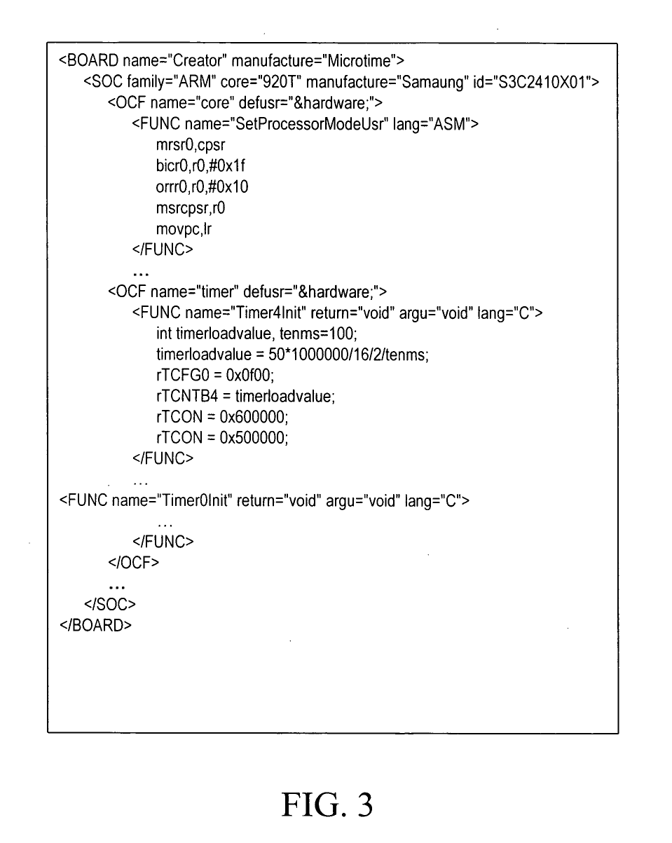

FIG. 3 is part of an example BSPXML document. This document details the hardware specification of Creator development board which is manufactured by Microtime Inc. Settings related to SoC processor, including processor mode, interrupt mode and mask, watchdog timer, etc, are described using the SoC element. The OCF child element is used to define On Chip Functions (OCF) used for OS. The SetProcessorModeUsr function shown in the example is defined for OS to change the processor to user mode. Similarly, TimerInit related functions are used to initialize on-chip timers. Hardware manufacturers should provide these OCFs and attach assembly or C code in the element body.

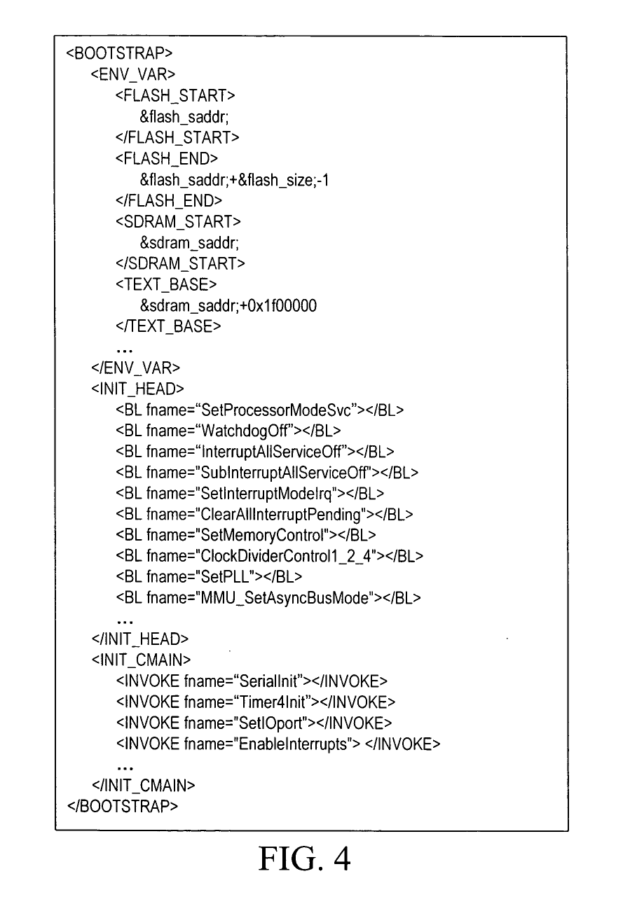

As shown in FIG. 4, the system developers 30 describe booting process of an OS in the Bootstrap element for the BSP tool to generate the appropriate bootstrap code. The ENV_VAR child element defines environment variables used in an OS, such as the address space of SDRAM and Flash, the size of stack, etc. The INIT_HEAD and INIT_CMAIN child elements are used to describe sequentially the booting process in assembly and C code, respectively. OS can invoke these generated functions for initialing the target platform without much detail knowledge of the hardware specification and thus ease the porting problem. In the example BSPXML document of FIG. 4, the INIT_HEAD function first changes the processor to the svc mode, and then disables watchdog timer and interrupt, etc. The INIT_CMAIN function, which serves as C entry point, continues to initialize the target platform. Finally, after performing all the described booting process, the bootstrap code returns control to OS.

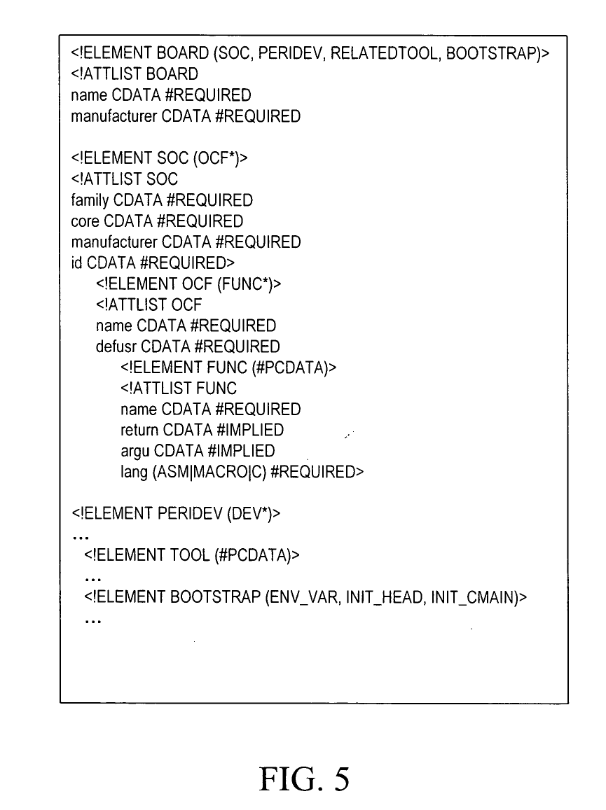

BSPXML is defined by BSPDTD. As shown in FIG. 5, the part of BSPDTD defines the SoC element and its child elements, OCF and FUNC. Necessary attributes are clearly defined in the BSPDTD so that independent manufacturers, OS programmers and system developers can use a common BSPXML. Also, BSPXML can be extended to support new hardware by modifying the BSPDTD. The BSPXML will become a unified and open platform to solve the porting problem in embedded systems.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An universal BSP tool for porting on embedded systems comprising:
a BSP parser used to parse a BSPXML document to obtain hardware specification of an embedded platform and booting process of an OS or application; and
a code generator used to receive information such as hardware specification and booting process generated by said BSP parser and generate bootstrap code and low-level hardware control functions of said embedded platform to be used by said OS or application.

2. The universal BSP tool for porting on embedded systems as claimed in claim 1, wherein said BSPXML document is of XML format, and is open and reusable.

3. The universal BSP tool for porting on embedded systems as claimed in claim 1, wherein said BSPXML document can be extended by defining a BSP document type document (DTD), and said BSPDTD defines said BSPXML language to describe hardware specification of said embedded platform and booting process of said OS or application.

4. The universal BSP tool for porting on embedded systems as claimed in claim 1, wherein said hardware specification of said embedded platform described by said BSPXML document includes descriptions of available registers, memory mapping, codes to control said embedded platform, and tool chain used to develop said embedded platform.

5. The universal BSP tool for porting on embedded systems as claimed in claim 4, wherein said available registers includes register name, mapped memory address, register bit definition, and other details, of said embedded platform.

6. The universal BSP tool for porting on embedded systems as claimed in claim 4, wherein said memory mapping includes registers, ROM, RAM, flash memory and other mapping memory addresses on said embedded platform.

7. The universal BSP tool for porting on embedded systems as claimed in claim 4, wherein said tool chain includes compiler, debugger, libraries and other needed tools.

8. The universal BSP tool for porting on embedded systems as claimed in claim 1, wherein said booting process in said BSPXML document includes hardware initialization, loading operation system or application to memory, and other necessary steps during booting.

9. The universal BSP tool for porting on embedded systems as claimed in claim 1, wherein said BSPXML document can further include make files of said operation systems or applications.

10. The universal BSP tool for porting on embedded systems as claimed in claim 1, wherein said code generator makes use of descriptions of said BSPXML document to automatically create bootstrap code using a programming language for compiling and linking with said operation systems or applications to boot said embedded platform.

11. The universal BSP tool for porting on embedded systems as claimed in claim 1, wherein said low-level functions utilize a plurality of segments of codes in a programming language to directly control said embedded platform, including codes for accessing value stored in register and memory address and codes called by operation system or application to control hardware after booting.

12. The universal BSP tool for porting on embedded systems as claimed in claim 10, wherein said programming language can be assembly language, C language or other supported programming language of said embedded platform.

13. The universal BSP tool for porting on embedded systems as claimed in claim 11, wherein said programming language can be assembly language, C language or other supported programming language of said embedded platform.

14. The universal BSP tool for porting on embedded systems as claimed in claim 1, wherein said BSPXML documents defined in said BSPDTD is described via element declarations and attribute-list declarations.

15. The universal BSP tool for porting on embedded systems as claimed in claim 14, wherein said element declarations are used to name the allowable set of elements within said BSPXML document and specify whether and how declared elements and runs of character data may be contained within each element.

16. The universal BSP tool for porting on embedded systems as claimed in claim 14, wherein said attribute-list declarations are used to name the allowable set of attributes for each declared element, including the type of each attribute value.

17. An application method of an universal BSP tool for porting on embedded systems comprising the steps of:
providing a BSPXML document which describes hardware specification of a target platform to be ported and booting process of an OS or application to be ported;
using a BSP parser to parse said BSPXML document of said target platform and using a code generator to automatically create bootstrap code in a programming language; and
compiling and linking said bootstrap code with an operation system or application.

18. The application method of an universal BSP tool for porting on embedded systems as claimed in claim 17 wherein said BSPXML document is of XML format, and is open and reusable.

19. The application method of an universal BSP tool for porting on embedded systems as claimed in claim 17 wherein said BSPXML document can be extended by defining a BSP document type document (DTD), and said BSPDTD defines BSPXML rules to describe hardware specification of said embedded platform and booting process of said OS or application.

20. The application method of an universal BSP tool for porting on embedded systems as claimed in claim 17, wherein said programming language can be assembly language, C language or other supported programming language of said embedded platform.

21. The application method of an universal BSP tool for porting on embedded systems as claimed in claim 17, wherein said BSPXML documents defined in said BSPDTD is described via element declarations and attribute-list declarations.

22. The application method of an universal BSP tool for porting on embedded systems as claimed in claim 21, wherein said element declarations are used to name the allowable set of elements within said BSPXML document and specify whether and how declared elements and runs of character data may be contained within each element.

23. The application method of an universal BSP tool for porting on embedded systems as claimed in claim 21, wherein said attribute-list declarations are used to name the allowable set of attributes for each declared element, including the type of each attribute value.
